(19) United States
(12) Patent Application Publication
(10) Pub. No.: US 2019/0013544 A1
(43) Pub. Date: Jan. 10, 2019

(54) THIN-FILM BATTERY

(71) Applicant: STMicroelectronics (Tours) SAS, Tours (FR)

(72) Inventor: Delphine GUY-BOUYSSOU, Luynes (FR)

(73) Assignee: STMicroelectronics (Tours) SAS, Tours (FR)

(21) Appl. No.: 16/030,441

(22) Filed: Jul. 9, 2018

(30) Foreign Application Priority Data
Jul. 10, 2017 (FR) 1756493

(51) Int. Cl. H01M 10/0525; H01M 10/0562; H01M 10/0585; H01M 4/1391; H01M 4/1395; H01M 4/525; H01M 4/38

(52) U.S. Cl. CPC H01M 10/0525; H01M 10/0562; H01M 10/0585; H01M 2300/0068; H01M 4/1395; H01M 4/525; H01M 4/38; H01M 4/1391

(57) ABSTRACT

A thin-film battery of lithium-free type includes a stack of a positive electrode made of LiCoO₂, an electrolyte layer made of LiPON, and a negative electrode made of copper. An adhesive layer based on polyvinylidene chloride (PVDC) is positioned on a face of the negative electrode opposite the electrolyte layer.

### PRIORITY CLAIM

This application claims the priority benefit of French Application for Patent No. 1756493, filed on Jul. 10, 2017, the content of which is hereby incorporated by reference in its entirety to the maximum extent allowable by law.

### TECHNICAL FIELD

The present application relates to the field of thin-film batteries, and more particularly targets the field of what are referred to as lithium-free thin-film batteries.

### BACKGROUND

The terms “thin-film battery” or “microbattery” conventionally refer to an assembly comprising a carrier substrate and, on one face of the substrate, a stack of layers forming an active battery element, this stack including in particular a solid electrolyte layer between a negative electrode and a positive electrode. The total thickness of a thin-film battery is typically on the order of a few tens to a few hundreds of micrometres, for example between 25 and 250 μm, for an area from a few square millimetres to a few square centimetres, for example between 25 mm² and 25 cm², thereby allowing the battery to be accommodated in very small spaces and additionally allowing batteries exhibiting a greater or lesser degree of flexibility (depending on the characteristics of the carrier substrate) to be produced.

Multiple thin-film battery technologies have been proposed, including in particular the batteries referred to as lithium-metal batteries and the batteries referred to as lithium-free batteries.

Conventionally, a thin-film battery may comprise a stack consisting of a positive electrode, or cathode, made of lithium cobalt dioxide (LiCoO₂), an electrolyte layer made of lithium phosphorus oxynitride (LiPON), and a negative electrode, or anode, the overall assembly being covered with an encapsulation layer allowing access only to a positive terminal and a negative terminal of the battery.

In the case of a lithium-metal battery, the negative electrode is a layer of metallic lithium, deposited during fabrication of the battery, for example by means of physical vapor deposition (PVD) or by means of evaporation, between the step of depositing the electrolyte layer and the step of depositing the encapsulation layer. The negative electrode may additionally be covered by a conductive layer referred to as an anode current collector, for example made of copper, deposited between the step of depositing the metallic lithium layer and the step of depositing the encapsulation layer. One drawback of lithium-metal batteries is that the production of the metallic lithium layer entails substantial fabrication constraints in terms of process, pollution and safety.

In the case of a lithium-free battery, the negative electrode is a layer of copper, deposited directly on and in contact with the face of the electrolyte layer opposite the positive electrode, between the step of depositing the electrolyte layer and the step of depositing the encapsulation layer. Stated otherwise, the battery fabrication process does not include a step of depositing metallic lithium between the step of depositing the electrolyte layer and the step of depositing the encapsulation layer (hence the term “lithium-free”, which is defined to mean in the context of this application as “without deposition of metallic lithium during fabrication”, even though the battery does in fact contain lithium, in particular in its positive electrode and in its electrolyte). When such a battery is brought into service, i.e. during the first charging phase of the battery, a layer of metallic lithium is formed, by electrochemical deposition, at the interface between the LiPON electrolyte layer and the copper negative electrode. This layer arises due to the migration of lithium ions from the LiCoO₂ positive electrode towards the LiPON electrolyte and from the LiPON electrolyte towards the copper negative electrode where they are deposited in metallic form. When discharging, the lithium ions migrate back through the electrolyte towards the positive electrode, such that the layer of metallic lithium disappears or decreases in thickness. Next, the metallic lithium layer is reformed during each charging phase and disappears once more (at least partially) during each discharging phase of the battery.

One advantage of lithium-free batteries is that they are easier to fabricate than lithium-metal batteries, inasmuch as the process for fabricating them does not comprise a step of depositing metallic lithium.

In practice, however, lithium-free batteries suffer from poor performance and in particular a significant loss of capacity, after only a few battery charge and discharge cycles.

### SUMMARY

Thus, one embodiment provides a thin-film battery of lithium-free type, comprising a stack of a positive electrode made of LiCoO₂, an electrolyte layer made of LiPON, and a negative electrode made of copper, in which the face of the negative electrode opposite the electrolyte layer is covered with a first adhesive layer based on PVDC.

According to one embodiment, the first adhesive layer is covered with an encapsulation layer.

According to one embodiment, the encapsulation layer is a film of alu-PET type.

According to one embodiment, the encapsulation layer is a film made of mica or of zirconium.

According to one embodiment, the battery additionally comprises a second adhesive layer, separate from the first adhesive layer, between the first adhesive layer and the encapsulation layer.

According to one embodiment, the second adhesive layer is made of an elastomer of butyl type or of styrene-butadiene type.

According to one embodiment, the stack additionally comprises a cathode current collector on the positive electrode side opposite the electrolyte layer.

According to one embodiment, the stack is borne on a carrier substrate made of mica or of ceramic.

Another embodiment provides a method for fabricating a thin-film battery of lithium-free type, comprising the following steps: forming a positive electrode made of LiCoO₂; forming an electrolyte layer made of LiPON on and in contact with the positive electrode; forming a negative electrode made of copper on and in contact with the face of the electrolyte layer opposite the positive electrode; and depositing a first adhesive layer based on PVDC on and in contact with the face of the negative electrode opposite the electrolyte layer.

According to one embodiment, the method additionally comprises a step of depositing a second adhesive layer, separate from the first adhesive layer, on and in contact with the face of the first adhesive layer opposite the negative electrode.

### BRIEF DESCRIPTION OF THE DRAWINGS

These features and their advantages, along with others, will be presented in detail in the following description of particular embodiments, provided without limitation and in relation to the appended figures in which:

FIG. 1 is a cross-sectional view schematically representing one example of a thin-film battery of lithium-free type;

FIG. 2 is a partial schematic cross-sectional view of one example of one embodiment of a thin-film battery of lithium-free type; and

FIG. 3 is a partial schematic cross-sectional view of another example of one embodiment of a thin-film battery of lithium-free type.

### DETAILED DESCRIPTION

The various figures have not been drawn to scale and, in addition, in the various figures, elements that are the same have been referenced by the same references. For the sake of clarity, only those elements which are useful to the comprehension of the described embodiments have been shown and are described in detail. In particular, the production of the various layers forming a thin-film battery of lithium-free type has not been described in detail, since the embodiments described are compatible with the usual techniques for producing a lithium-free battery. In the following description, when reference is made to qualifiers of relative position, such as the terms “above”, “below”, “upper”, “lower”, etc., or to qualifiers of orientation, such as the terms “horizontal”, “vertical”, etc., reference is being made to the orientation of the figures, it being understood that, in practice, the batteries described may be oriented differently. Unless specified otherwise, the expressions “approximately”, “substantially” and “on the order of” signify to within 10%, preferably to within 5%.

Furthermore, in the present description, the negative electrode of a thin-film battery refers to the first metallic layer deposited during fabrication of the battery, on and in contact with the face of the electrolyte layer opposite the positive electrode, in the active portion of the battery, namely a layer of metallic lithium in the case of a battery of lithium-metal type and a layer of copper in the case of a battery of lithium-free type.

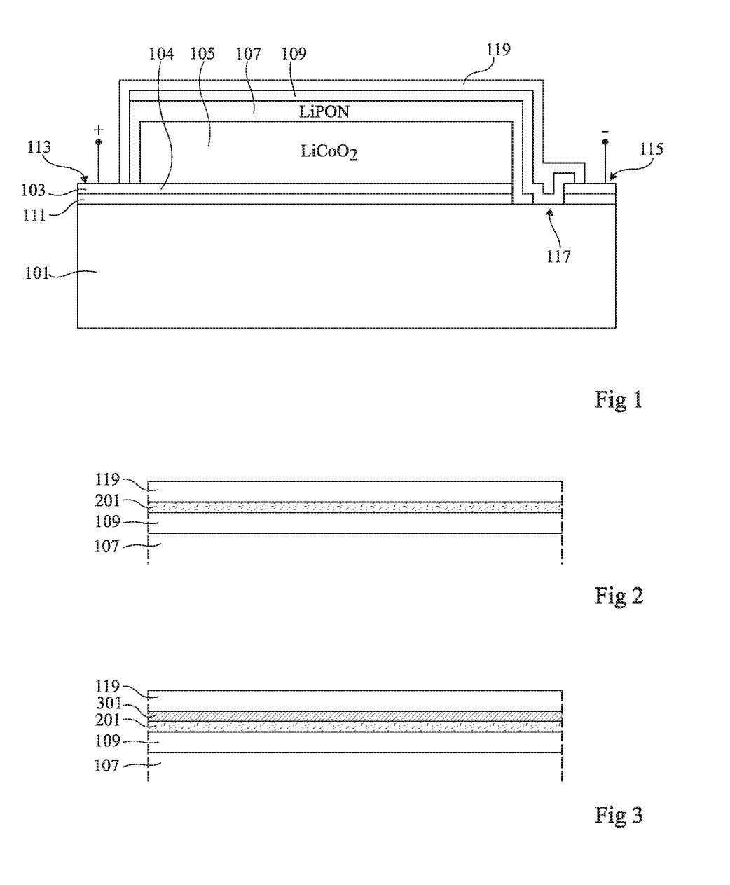

FIG. 1 is a cross-sectional view schematically representing one example of a thin-film battery of lithium-free type.

The battery of FIG. 1 comprises a carrier substrate 101, for example made of mica or of ceramic, and, above the upper face of the substrate 101, a stack including, in order from the upper face of the substrate, a conductive layer 103, for example made of platinum or of gold, in which a cathode current collector 104 is formed, a layer 105 made of LiCoO₂, forming the positive electrode or cathode of the battery, a layer 107 made of LiPON, forming the electrolyte of the battery, and a layer 109 made of copper, forming the negative electrode of the battery.

In the example shown, a tie layer 111, for example made of lithium cobalt oxynitride (LiCoON), forms the interface between the substrate 101 and the layer 103. The layer 111 is positioned on and in contact with the upper face of the substrate 101, and the layer 103 is positioned on and in contact with the upper face of the layer 111. Moreover, in this example, the layer 105 is positioned on and in contact with the upper face of the layer 103, the layer 107 is positioned on and in contact with the upper face of the layer 105, and the layer 109 is positioned on and in contact with the upper face of the layer 107.

The thickness of the layer 103 is, for example, between 50 nm and 5 μm, for example on the order of 100 nm. The thickness of the layer 105 is, for example, between 2 and 50 μm, for example on the order of 10 μm. The thickness of the layer 107 is for example between 0.5 and 5 μm, for example on the order of 2 μm. The thickness of the layer 109 is, for example, between 50 nm and 1 μm, for example on the order of 100 nm.

In the example of FIG. 1, the positive electrode 105 forms a plateau or mesa borne on a central portion of the carrier substrate 101, and defining, when seen from above, the active portion of the battery. The electrolyte layer 107 entirely covers the upper face of the positive electrode 105, and additionally covers the flanks of the positive electrode 105 such that the positive electrode 105 is entirely encapsulated by the electrolyte layer 107 on the one hand and by the current collector 104 on the other hand.

The battery additionally comprises, on the upper face of the carrier substrate 101, in a peripheral portion of the carrier substrate that is not covered by the layer 105, a positive contact terminal 113 (to the left of the active portion of the battery in the orientation of FIG. 1) and a negative contact terminal 115 (to the right of the active portion of the battery in the orientation of FIG. 1), which are intended to be connected to an external device. The positive terminal 113 is electrically connected to the cathode current collector 104, and the negative terminal 115 is electrically connected to the negative electrode 109. In this example, the positive terminal 113 is formed by a section of the conductive layer 103 that is contiguous with (and hence electrically connected to) the cathode current collector 104. The negative terminal 115 is itself formed by a section of the conductive layer 103 that is separated from the cathode current collector 104 and from the positive terminal 113 (so as not to short the battery). In the example shown, the section of the tie layer 111 located below the negative terminal 115 and the section of the tie layer 111 located below the cathode current collector 104 and below the positive terminal 113 are additionally separated so as to avoid the risk of shorting the battery. Stated otherwise, an opening 117 extending vertically through the layers 103 and 111 and opening onto the substrate 101, between the negative terminal 115 and the cathode current collector 104, electrically insulates the positive terminal 113 from the cathode current collector 104.

The conductive layer 103 covers the upper face of the LiPON layer 107, and extends down to the negative terminal 115 of the battery, passing over a flank of the active stack (the right-hand flank in the orientation of FIG. 1), as well as over the lateral walls and over the bottom of the opening 117. In this example, the LiPON layer 107 extends at least over the flank of the opening 117, which flank is located on the current collector 104 side, down to the bottom of the opening 117, such that the negative electrode layer 109 is fully electrically insulated from the positive electrode 105 and from the cathode current collector 104 by the layer 107.

The battery of FIG. 1 additionally comprises an encapsulation layer 119 that entirely covers the upper face and the flanks of the active stack and allows access only to the positive 113 and negative 115 terminals of the battery on the upper face side of the substrate 101.

By way of example, in order to produce the battery of FIG. 1, the layers 111, 103, 105, 107 and 109 are first deposited in succession on the upper surface of the substrate 101, for example using sputtering techniques through shadow masks in order to localize the various layers, followed by the deposition of the encapsulation layer 119 on the stack, for example by means of rolling.

By way of example, the encapsulation layer 119 is an aluminum film covered (on the side of its face opposite the substrate 101) with polyethylene terephthalate (PET), also known by the abbreviation alu-PET, which has the advantage of being highly flexible and hence particularly well-suited to thin-film batteries that are intended to conform to the electronic devices in which they are integrated.

In practice, an adhesive layer (not visible in FIG. 1) forms the interface between the active stack of the battery and the encapsulation layer 119, in particular for the purpose of attaching the encapsulation layer 119. In the case of an encapsulation layer of alu-PET type, an additional function of the adhesive layer is to electrically insulate the negative electrode 109 from the aluminum film of the encapsulation layer 119, in order to avoid any risk of the aluminum film of the layer 119 shorting the battery.

After numerous unsuccessful tests attempting to solve the problems of loss of capacity observed in thin-film batteries of lithium-free type, the applicant has identified that the loss of capacity could be linked to the adhesive used to attach the encapsulation layer 119 to the battery. More particularly, studies carried out by the applicant have shown that among the main families of adhesive commonly used for the purpose of attaching the encapsulation layer of a thin-film battery, the majority tend to react with the metallic lithium formed on the negative electrode side (by diffusion through the copper layer forming the negative electrode) during the first charging phase of the battery, preventing the return migration of the lithium in the following discharging phase. In particular, the inventors have identified that butyl-type elastomers (PIB), commonly used for the purpose of attaching encapsulation layers of alu-PET type, block the return migration of the lithium in the battery, thereby greatly limiting the capacity of the battery.

However, the applicant has identified that polyvinylidene chloride (PVDC)-based polymers do not exhibit this drawback, and allow the capacity of the battery to be maintained in the long term.

Thus, according to one aspect of one embodiment, a thin-film battery of lithium-free type is provided, comprising a stack of a positive electrode made of LiCoO₂, an electrolyte layer made of LiPON, and a negative electrode made of copper, in which the face of the negative electrode opposite the electrolyte layer is covered with an adhesive layer based on PVDC.

FIG. 2 is a partial schematic cross-sectional view of one exemplary embodiment of such a battery. The battery of FIG. 2 comprises elements in common with the battery of FIG. 1. Throughout the remainder, only the differences between the two batteries will be described in detail. In the example of FIG. 2, only the layers 107, 109 and 119 of the battery of FIG. 1 have been partially shown.

FIG. 2 additionally shows a PVDC-based adhesive layer 201, forming the interface between the upper face of the negative electrode 109 and the lower face of the encapsulation layer 119.

The layer 201 is positioned on and in contact with the upper face of the negative electrode layer 109, for example over the entire surface of the negative electrode layer 109. In the example of FIG. 2, the encapsulation layer is positioned on and in contact with the upper face of the layer 201. The layer 201 may be deposited after the step of depositing the negative electrode layer 109 and before the step of depositing the encapsulation layer 119, for example by means of sputtering or by dipping the battery in a bath of PVDC-based adhesive. By way of example, the thickness of the layer 201 is between 10 and 50 μm, for example on the order of 20 μm.

The layer 201 comprises for example at least 80% PVDC, and preferably at least 90% PVDC. By way of example, the layer 201 is made of pure PVDC, i.e. it solely comprises PVDC, with trace amounts of optional additional compounds. The adhesive material is for example formed by mixing powdered PVDC with a solvent, for example methyl ethyl ketone (MEK). The mixture is next deposited on and in contact with the upper face of the negative electrode layer 109, followed by the evaporation of the solvent.

The encapsulation layer 119 is for example a film of alu-PET type, bonded by its aluminum face directly to the adhesive layer 201. As a variant, the encapsulation layer 119 is a film made of mica, of zirconium, or of any other suitable encapsulation material.

The tests carried out by the applicant have shown that placing the layer 201 in direct contact with the upper face of the negative electrode layer 109 leads to a drastic improvement in the performance of the battery with respect to a battery produced using another adhesive for attaching the encapsulation layer.

FIG. 3 is a partial schematic cross-sectional view of one variant embodiment of the battery of FIG. 2.

The battery of FIG. 3 differs from the battery of FIG. 2 in that it additionally comprises, between the PVDC-based adhesive layer 201 and the encapsulation layer 119, an additional adhesive layer 301 of a different nature, for example a layer of a butyl-type elastomer, or else a layer of a styrene-butadiene-type elastomer. The layer 301 is positioned on and in contact with the upper face of the layer 201, the encapsulation layer 119 being positioned on and in contact with the upper face of the layer 301.

The variant embodiment of FIG. 3 makes it possible to benefit both from the drastic improvement in the performance of the battery linked to placing a PVDC-based adhesive layer 201 in direct contact with the upper face of the negative electrode 109 and from other useful properties that are likely to be exhibited by adhesives of different natures, for example improved electrical insulation, enhanced power of adhesion to certain encapsulation materials, etc. This variant also makes it possible to facilitate the deposition of the encapsulation layer 119 by means of rolling on the layer 201, the encapsulation layer 119 being capable of being pre-coated with the additional adhesive layer 301. This allows good adhesion to be obtained between the encapsulation layer 119 and the layer 201 without having to exert mechanical or thermal stress that is liable to damage the battery.

Particular embodiments have been described. Diverse variants and modifications will be apparent to those skilled in the art. In particular, the embodiments described are not limited to the particular example of a battery structure described with reference to FIG. 1. More generally, the embodiments described are compatible with any common structures of thin-film batteries of lithium-free type.

In addition, the embodiments described are not limited to the examples of dimensions, and in particular of thicknesses of the various layers, mentioned in the present application.

1. A thin-film battery of lithium-free type, comprising a stack of:
a positive electrode made of LiCoO₂,
an electrolyte layer made of LiPON,
a negative electrode made of copper deposited on and in contact with a face of the electrolyte layer, and
a first adhesive layer based on polyvinylidene chloride (PVDC) deposited on and in contact with a face of the negative electrode opposite the electrolyte layer.

2. The battery according to claim 1, wherein the first adhesive layer is covered with an encapsulation layer.

3. The battery according to claim 2, wherein the encapsulation layer is a film of alu-PET type.

4. The battery according to claim 2, wherein the encapsulation layer is a film made of mica or of zirconium.

5. The battery according to claim 2, further comprising a second adhesive layer, separate from the first adhesive layer, positioned between the first adhesive layer and the encapsulation layer.

6. The battery according to claim 5, wherein the second adhesive layer is made of an elastomer of butyl type or of styrene-butadiene type.

7. The battery according to claim 1, wherein said stack additionally comprises a cathode current collector on the positive electrode side opposite the electrolyte layer.

8. The battery according to claim 1, wherein said stack is borne on a carrier substrate made of mica or of ceramic.

9. A method for fabricating a thin-film battery of lithium-free type, comprising:
forming a positive electrode made of LiCoO₂;
forming an electrolyte layer made of LiPON on and in contact with the positive electrode;
forming a negative electrode made of copper on and in contact with a face of the electrolyte layer opposite the positive electrode; and
depositing a first adhesive layer based on polyvinylidene chloride (PVDC) on and in contact with a face of the negative electrode opposite the electrolyte layer.

10. The method according to claim 9, further comprising depositing a second adhesive layer, separate from the first adhesive layer, on and in contact with the face of the first adhesive layer opposite the negative electrode.
